(19) United States
(12) Patent Application Publication
(10) Pub. No.: US 2015/0269613 A1
(43) Pub. Date: Sep. 24, 2015

(54) Network-Adaptive Ad Modality Selection

(71) Applicant: YAHOO! INC., Sunnyvale, CA (US)

(72) Inventor: Bruno M. Fernandez-Ruiz, London (GB)

(73) Assignee: YAHOO! INC., Sunnyvale, CA (US)

(21) Appl. No.: 14/344,145

(22) PCT Filed: Mar. 15, 2013
(86) PCT No.: PCT/CN2013/000297

§ 371 Date: Mar. 11, 2014

(51) Int. Cl. G06Q 30/02

(52) U.S. Cl. CPC G06Q 30/0251

(57) ABSTRACT

A method for adjusting delivery of electronic advertisement to a user device. The method comprises receiving a request for an electronic advertisement asset, where the request includes one or more indicators associated with at least one of the user device and at least one network condition in relation to the user device and determining a modality of delivery of the electronic advertisement asset based on the one or more indicators. The method further comprises transmitting the electronic advertisement asset in the determined modality to the user device in response to the request.

### TECHNICAL FIELD

The present disclosure relates generally to advertising. Specifically, the present disclosure relates to electronic advertising.

### BACKGROUND

Internet content providers frequently rely on advertising revenue in order to support the cost of providing other content for the users. In recent years, the types of electronic advertising that is available for presentment to user devices has expanded from simple HyperText Markup Language (HTML) links to various types of multimedia advertising.

As such, the amount of network resources, including network bandwidth, that is needed to deliver the multimedia advertising has increased. This presents a particular challenge in connection with delivery of electronic advertising to user devices that are subject to varying network conditions, such as mobile devices or devices that are connected to networks under heavy load or generally experiencing reduced connectivity. Additionally, not all mobile devices are capable of supporting all kinds of multimedia advertising modalities, whether due to hardware or operating system limitations.

For instance, when a mobile device connected to a network experiencing poor network conditions accesses a web page that includes a request for multimedia-heavy advertising, the user experience may suffer if the network is not able to timely fulfill the advertising request included in the web page. Present solutions, such as responsive ad formats, do not address this issue because they require delivery of the requested ad unit to the user device irrespective of network conditions and user device type and merely allow the delivered ad unit to change, while already on the user device, in accordance with the device resolution, screen size, or orientation. Since the ad unit is delivered to the user device in the requested modality (e.g., multimedia type advertising), the user experience will still suffer during deteriorated network conditions or when delivered to a user device that is not capable of supporting the delivered multimedia advertising.

### SUMMARY

The teachings disclosed herein relate to methods, systems, and programming for delivering advertising units to a user device. More particularly, the present teaching relates to methods, systems, and programming for selecting an add asset for delivery to the user device in view of the current network conditions and/or user device parameters.

In one embodiment, a method for adjusting delivery of electronic advertisement to a user device is provided. The method is implemented on a computing device having at least one processor, storage, and a communication interface connected to a network. The method comprises receiving a request for an electronic advertisement asset, where the request includes one or more indicators associated with at least one of the user device and at least one network condition in relation to the user device and determining a modality of delivery of the electronic advertisement asset based on the one or more indicators. The method further comprises transmitting the electronic advertisement asset in the determined modality to the user device in response to the request.

In another embodiment, a system for adjusting delivery of electronic advertisement to a user device is provided. The system comprises a network conditions parser module configured to parse an electronic advertisement asset request for one or more indicators associated with at least one of the user device and at least one network condition in relation to the user device. The system further includes an advertisement modality determiner module configured to determine a modality for delivery of the electronic advertisement by identifying whether an electronic advertisement asset in the request is supported for the one or more indicators. The system further comprises an electronic advertisement request constructor module configured to cause delivery of the electronic advertisement to the user device in accordance with the determined format.

In yet another embodiment, a non-transitory computer readable medium having recorded thereon information for adjusting delivery of electronic advertisement to a user device is provided, wherein the information, when read by the computer, causes the computer to perform a plurality of steps. The steps include receiving an electronic advertisement asset request having one or more indicators associated with at least one of the user device and at least one network condition in relation to the user device, determining a modality for delivery of the electronic advertisement by identifying whether an electronic advertisement asset in the request is supported for the one or more indicators, and transmitting the electronic advertisement asset in the determined modality to the user device in response to the request.

The following detailed description together with the accompanying drawings will provide a better understanding of the nature and advantages of various embodiments of the present teaching.

### DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a diagram illustrating a user device interface screen having a plurality of content panes;

FIG. 2 is a diagram illustrating another user device interface screen having a plurality of content panes, some of which correspond to content transformed in accordance with an embodiment of the present teaching;

FIG. 3 is a diagram illustrating a system environment in which an ad modality selection server is deployed, in accordance with one embodiment of the present teaching;

FIG. 4 is a diagram illustrating a system environment in which an ad modality selection server is deployed, in accordance with another embodiment of the present teaching;

FIG. 5 is a diagram illustrating an embodiment of the ad modality selection server of FIGS. 3-4 in further detail, in accordance with an embodiment of the present teaching;

FIG. 6 is a diagram illustrating an embodiment of the ad modality determiner module of FIG. 5 in further detail, in accordance with an embodiment of the present teaching;

FIG. 7 is a flow chart illustrating an embodiment of a method for adjusting delivery of electronic advertisement to a user device, in accordance with an embodiment of the present teaching;

FIG. 8 is a diagram illustrating an embodiment of the user device of FIGS. 3-4 in further detail, in accordance with an embodiment of the present teaching;

FIG. 9 is a flow chart illustrating an embodiment of a method for processing an ad request by the user device of FIGS. 3-4, in accordance with an embodiment of the present teaching;

FIG. 10 is a diagram illustrating a user device, on which at least a part of the present teaching can be implemented; and

FIG. 11 is a diagram illustrating a general computer architecture on which at least a part of the present teaching can be implemented.

### DESCRIPTION OF EXEMPLARY EMBODIMENT(S)

The following example embodiments and their aspects are described and illustrated in conjunction with apparatuses, methods, and systems which are meant to be illustrative examples, not limiting in scope.

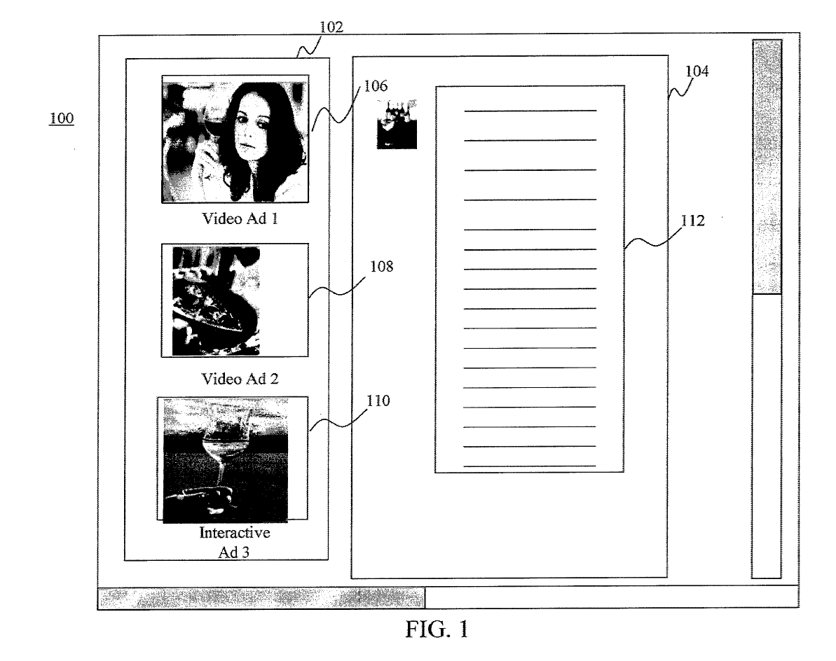

FIG. 1 illustrates a user device interface screen 100 having a plurality of content panes. In particular, content pane 102 includes advertising content, such as ads 106-110, while the content pane 104 includes user selected content 112. In the illustrated embodiment, the ads 106-110 are rich media type multimedia ads displayed by the user device when the network conditions permit delivery of corresponding ad formats.

For instance, the ad 106 requires delivery of video assets to the user device in order to stream video content from an ad server when the user device detects user interest, such as hovering over the ad or otherwise selecting an option to play the ad. Similarly, ad 108 is an audio/video ad that requires delivery of both audio and video assets to the user device. Additionally, ad 110 is an interactive ad that, in one embodiment, expands over a larger area of the user device screen 100 upon detection of user interest. In an embodiment, when the user device renders a web page via the interface screen 100, it parses embedded ad tags, which are computer executable instructions that request particular ad units having the underlying ad data from an ad server via ad tag call messages. Alternatively or in addition, the ad tags originate from a native application on the user device which invokes a view to display web content, such as via an Android™ WebView with an iframe containing the ad tags. The ad format or modality specified in an ad tag call requires delivery of a corresponding ad asset (e.g., video, audio, static image, text, animation, or an interactive ad data, among others) from the ad server in order for the user device to display the ad. The requested ad asset is delivered to the user device via an ad tag call response message.

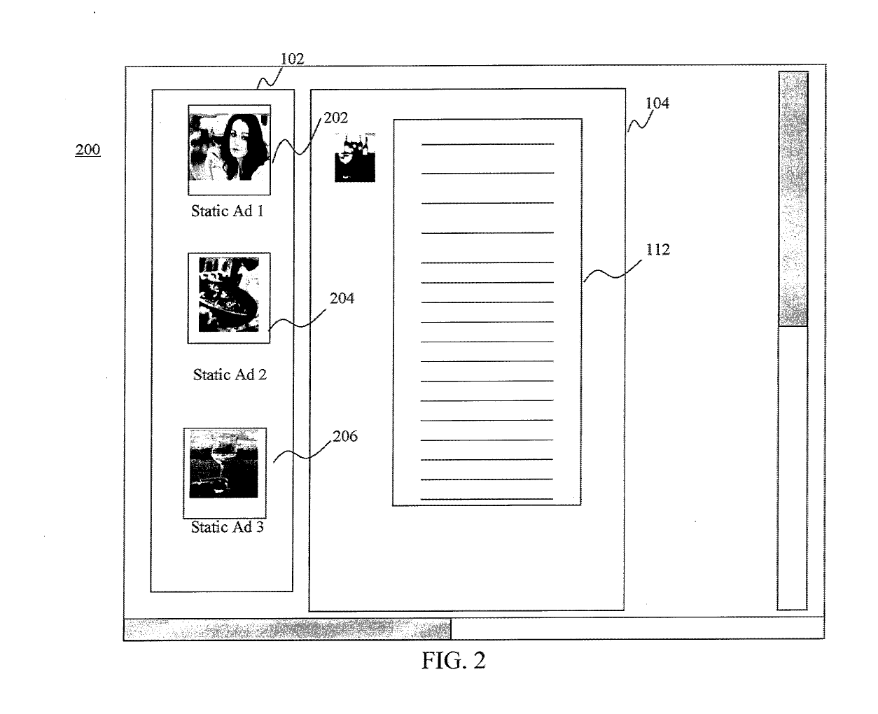

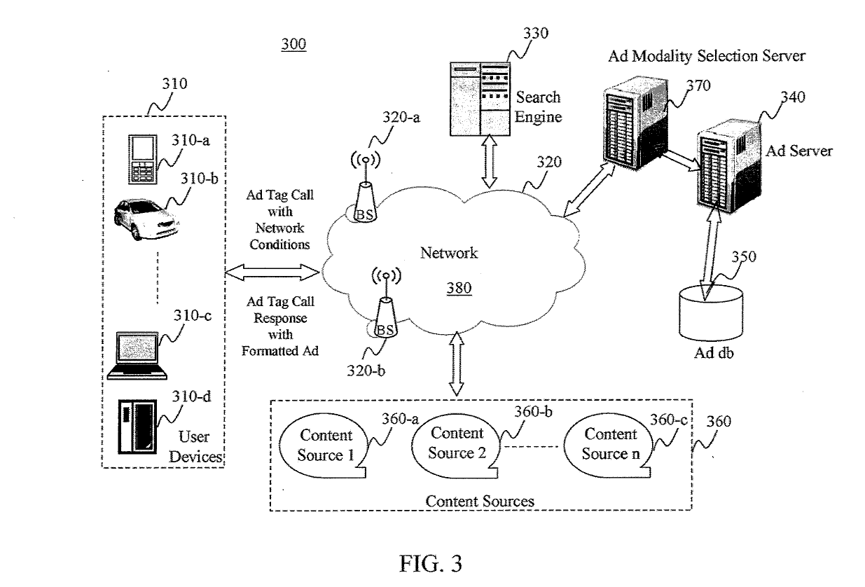

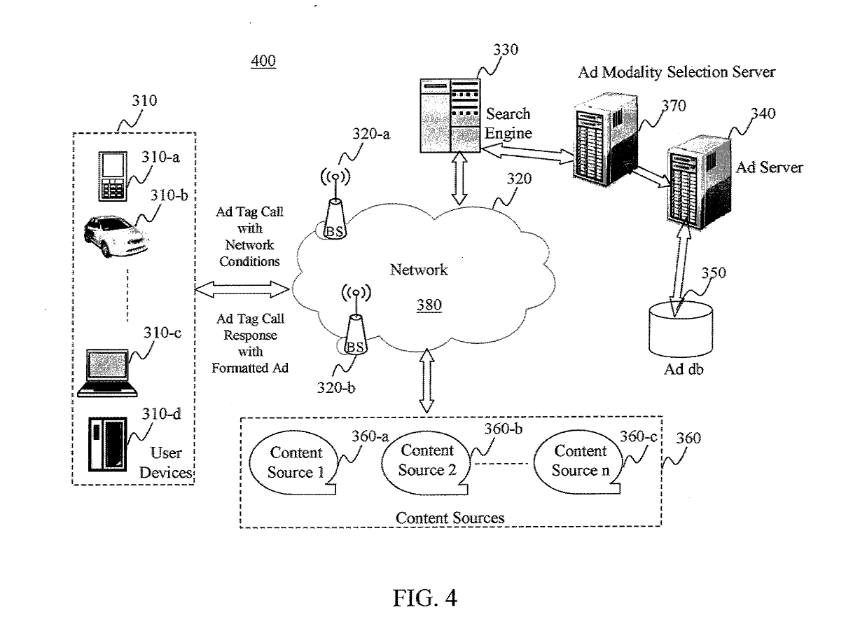

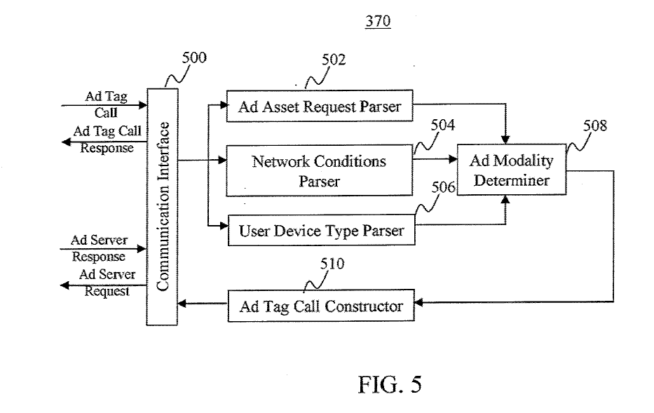

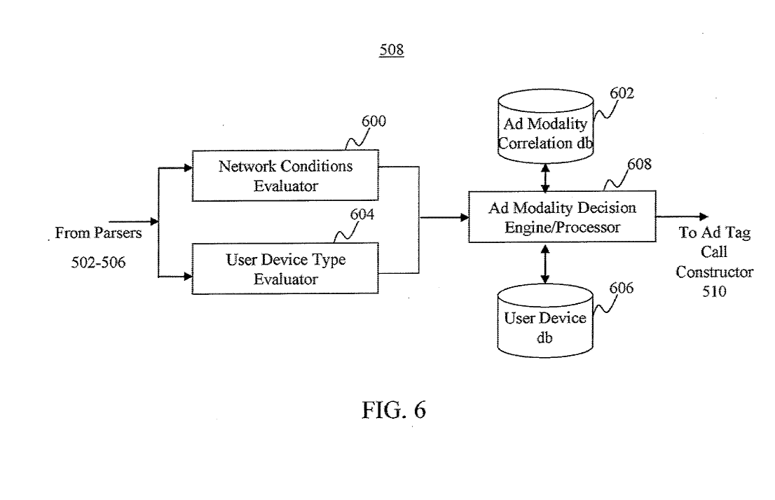

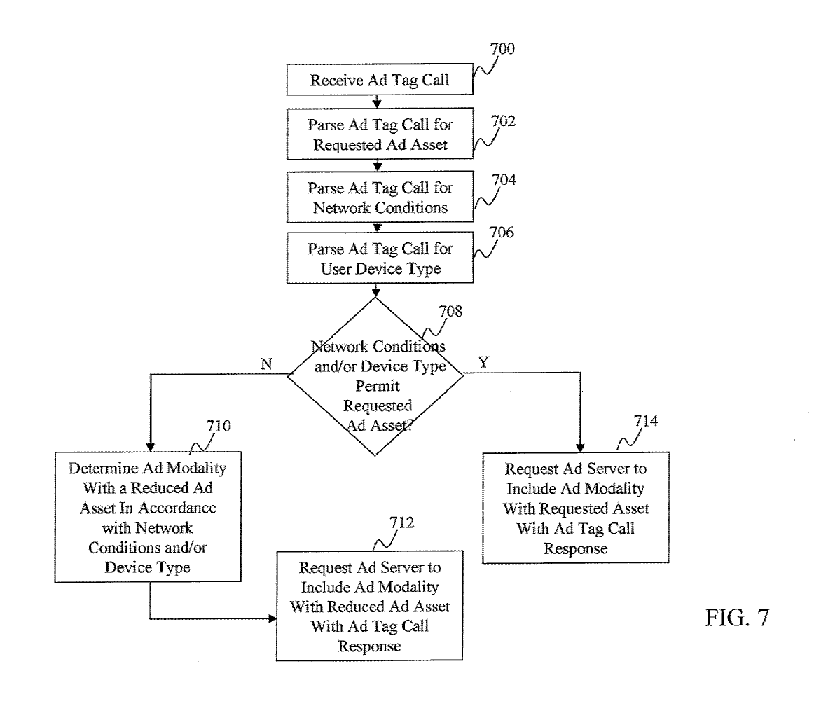

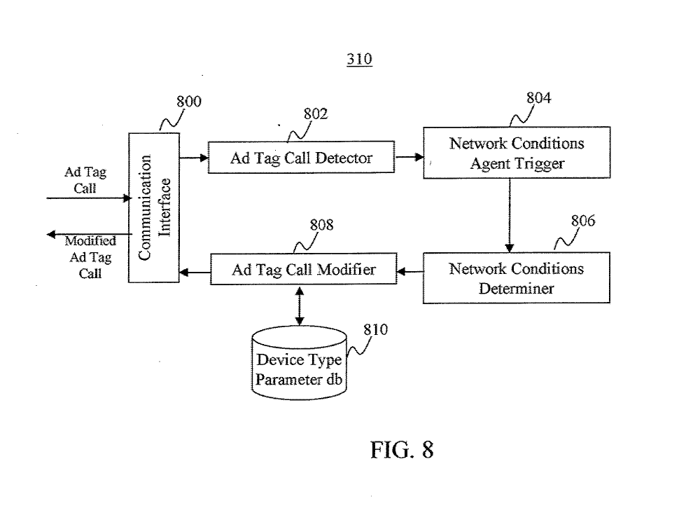

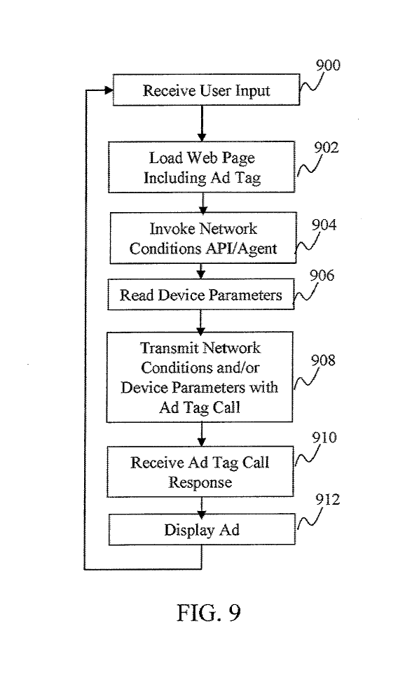

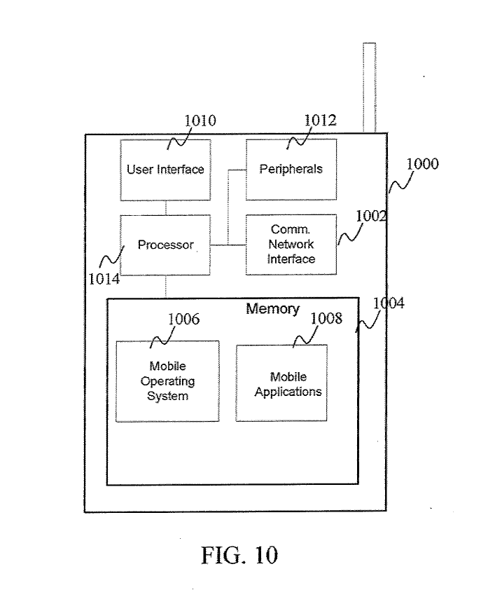

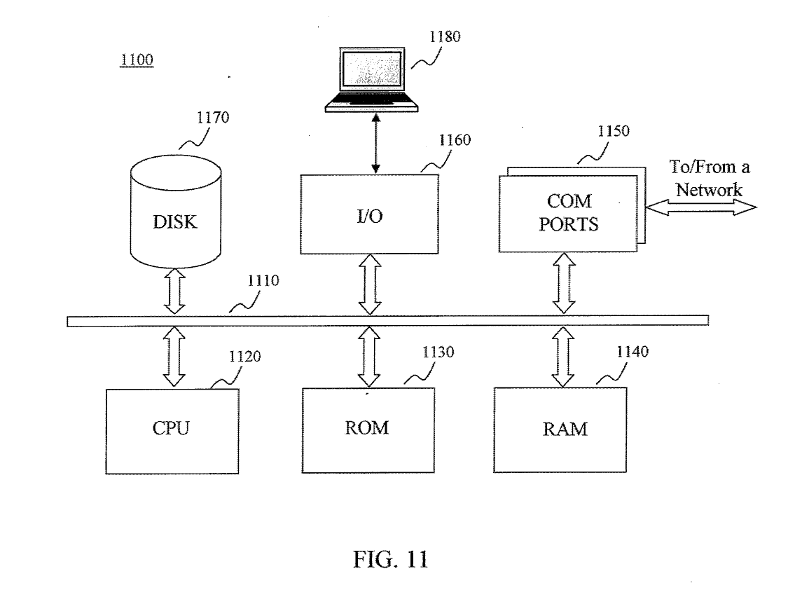

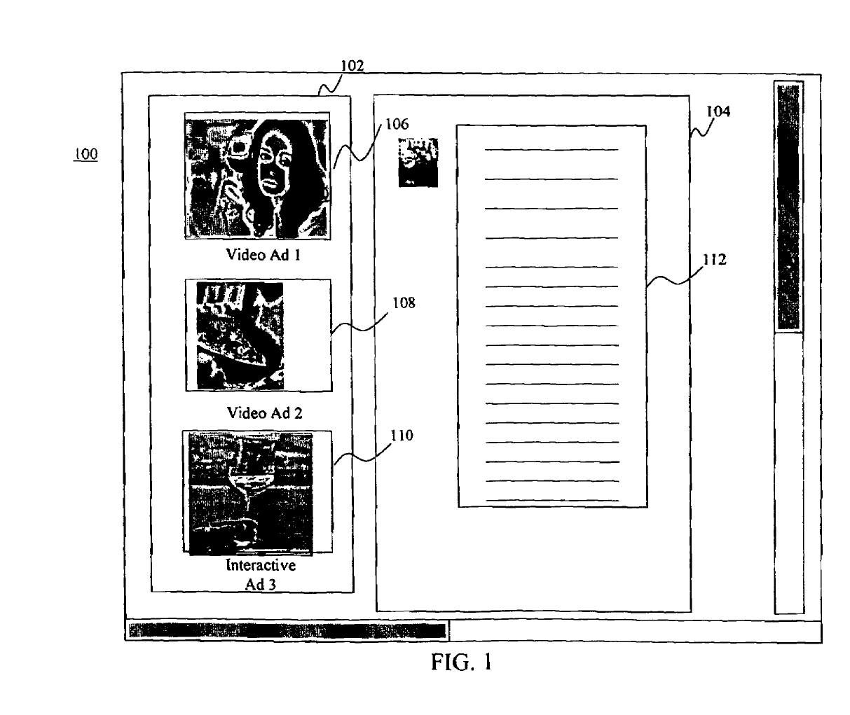

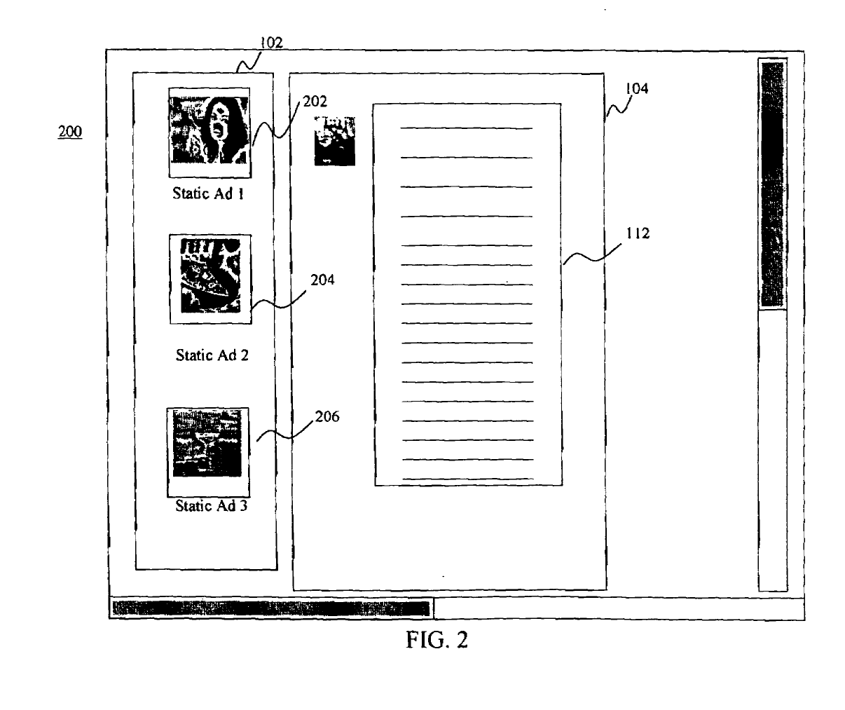

As discussed in further detail below, embodiments of the present disclosure modify the ad format or modality specified in the ad tag call in accordance with the network conditions associated with the user device and/or in accordance with the user device parameters when the user device requests delivery of a particular ad asset. For example, as illustrated in FIG. 2, when the network conditions associated with the user device deteriorate, the ad modality selected for delivery to the user device is adjusted by way of selecting an alternate ad modality associated with reduced ad assets that are appropriate for the current network conditions. Alternatively or in addition, the ad modality selected for the user device may be altered in accordance with user device parameters. As shown in FIG. 2, the user screen 200 includes ads 202-206 which were delivered in an alternate ad format corresponding to static images (e.g., rather than rich media ads 106-110) in order to prevent degradation of user experience under current network conditions and/or to take into account user device limitations. In an embodiment, an agent embedded in an application running on a user device, detects network conditions associated with the user device and embeds one or more indicators associated with the network conditions into the ad tag call. Additionally, the user device embeds user device parameters into the ad tag call for further ad tag call response customization.

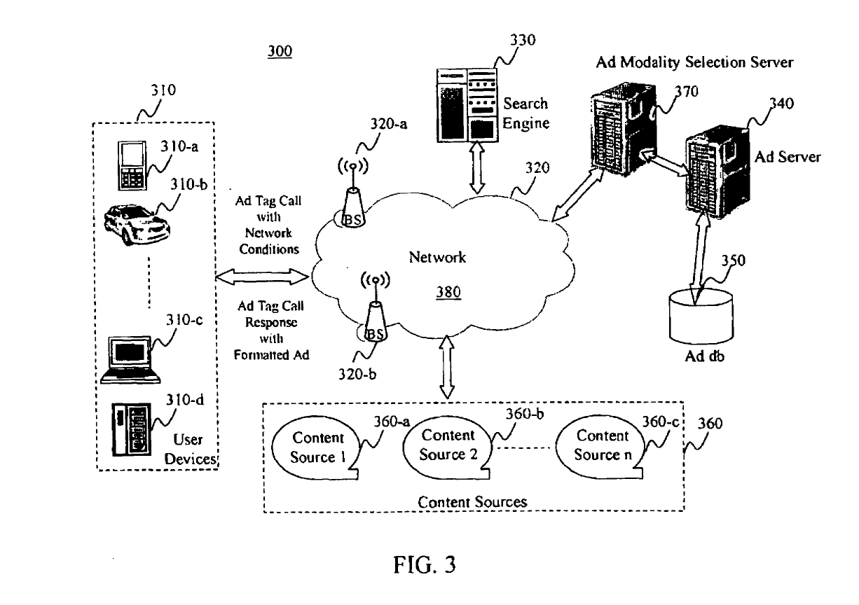

FIG. 3 is a high level depiction of an exemplary system 300 in which an ad modality selection server 370 is deployed to manage ad asset modality selection in view of the network conditions and/or user device parameters, according to a first application embodiment of the present teaching. The exemplary system 300 includes user devices 310, a network 380, a search engine 330, content sources 360, an ad modality selection server 370, an ad server 340, and a ad database 350. The network 380 in system 300 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points 320-a, 320-b, through which a data source may connect to the network in order to transmit information via the network. In a wireless network embodiment, the network 380 is a wireless wide area network, including a network that employs a cellular-based wireless standard, such as CDMA 2000, EV-DO, EV-DV, GSM, GPRS, EDGE, HSPDA, UMTS (Universal Mobile Telecommunications System), LTE (3GPP Long Term Evolution), or UMB (Ultra Mobile Broadband) network access technology. In other embodiments, the network 104 is a LAN (Local Area Network), a WLAN (Wireless Local Area Network) (e.g., Wi-Fi®), or a WiMAX® network.

User devices 310 include desktop computers (310-d), laptop computers (310-c), handheld devices (310-a), or built-in devices in a motor vehicle (310-b) that connect to the network 380. A user may send a query to the search engine 330 via the network 380 and receive a query result from the search engine 330 through the network 380. When the user selects one of the query results, the user device 310 loads the corresponding web page including an embedded ad tag for causing a display of a specified ad unit, as illustrated in FIGS. 1 and 2. In particular, the user device embeds network conditions and/or user device parameters into an ad tag call message and forwards the ad tag call to the ad modality selection server 370 via the network 380. The ad modality selection server 370, in turn, determines whether the ad asset requested in the ad tag is appropriate in view of the network conditions and/or user device parameters included in the ad tag call and, if deemed necessary, modifies the ad tag call by substituting a request for an appropriate ad asset. The ad modality selection server 370 then forwards the ad tag call to the ad server 340, which obtains an ad unit with the requested ad asset from the ad database 350 and returns the ad unit to the user device 310 in an ad call response via the network 380.

The content sources 360 include multiple content sources 360-a, 360-b, . . . , 360-c. A content source may correspond to a web page host corresponding to an entity, whether an individual, a business, or an organization such as USPTO.gov, a content provider such as cnn.com and Yahoo.com, or a content feed source such as Tweeter or blogs. The search engine 330 may access information from any of the content sources 360-a, 360-b, . . . , 360-c and may rely on such information to respond to a query (e.g., the search engine 330 identifies content related to keywords in the query and returns the result to a user). In various embodiments, the ad modality selection server 370 may be running on the search engine 330, at the backend of the search engine 330, on the ad server 340, or as a completely stand-alone system capable of connecting to the other system components via the network 380.

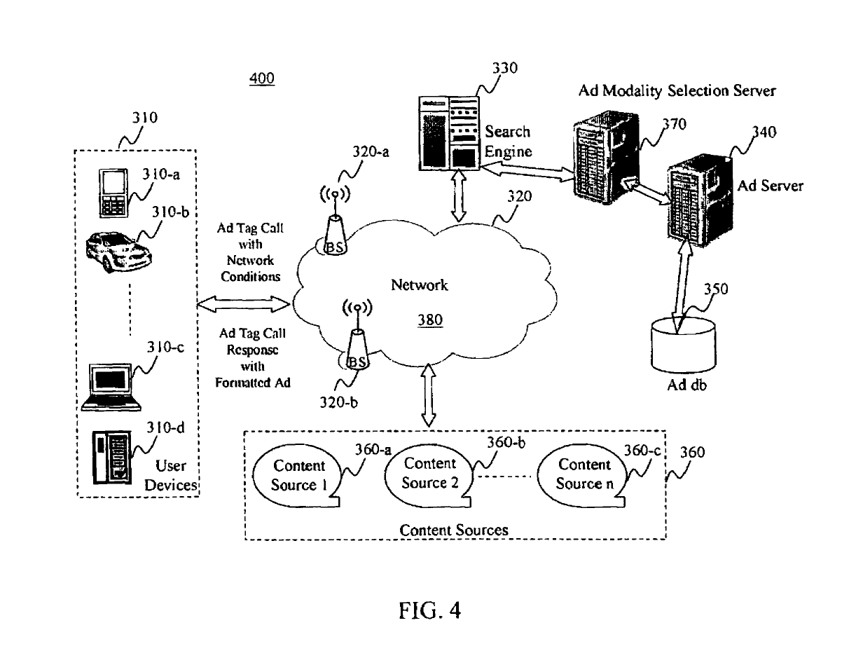

FIG. 4 is a high level depiction of an exemplary system 400 in which the ad modality selection server 370 serves as a backend system of the search engine 330. In this embodiment, all inquiries, including the query for content and the ad tag call messages are sent through the search engine 330, which then invokes the ad modality selection server 370 for further processing as described herein.

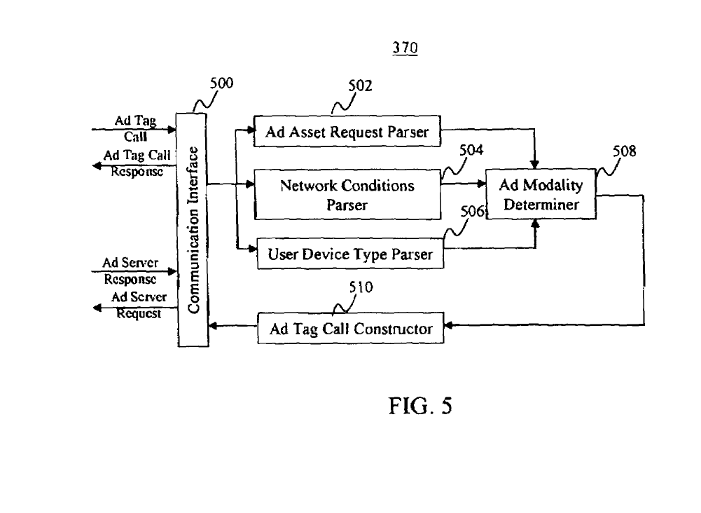

FIG. 5 illustrates an embodiment of the Ad modality selection server 370 in further detail. The communication interface 500 receives an ad tag call with embedded network conditions and user device parameters from the user device 310 and forwards the ad tag call to ad tag call parser modules 502-506. In particular, the ad asset request parser module 502 identifies the ad asset requested with the ad tag call and communicates the identified ad asset information to the ad modality determiner module 508. The network conditions parser module 504, in turn, filters one or more indicators of network conditions seen by the user device from the ad tag call. In various embodiments, the network conditions include indicators of network latency times, received signal strength (RSSI) at the user device, overall Quality of Service (QoS) experienced by the user device, an error rate (e.g., bit error rate (BER), and signal-to-noise ratio (SNR) (including by way of example carrier-to-noise ratio (CNR), energy per bit to-noise ratio (Eb/No), energy per chip-to-interference ratio (Ec/Io), and the like). In embodiments, the network conditions indicators may be separate indicators or may be aggregated into an overall indicator, such as by way of calculating an overall network conditions score using score scales and weights assigned to each of the stand-alone network conditions indicators and calculating an average.

The user device type parser module 506 parses user device related parameters from the ad tag call and forwards the parsed information to the ad modality determiner module 508. In an embodiment, the user device parameters include device type (e.g., smart mobile phone, basic mobile phone, laptop, desktop), screen size, screen resolution, processor type, amount of total video memory, amount of currently available video memory, RAM/ROM amount, current processor load, and the like.

The ad modality determiner module 508 receives information identifying the requested ad asset, current network conditions, as well as user device parameters, from the parsers 502-506 and determines an appropriate ad modality corresponding to the current network conditions. For example, when the network conditions information received with the ad tag call corresponds to increased network latency or one or more other indicators associated with deteriorated network conditions, the ad modality determiner module 508 identifies a reduced ad asset that is better suited for delivery to the user device in order to preserve the user experience. For instance, when the ad tag call includes a request to deliver an ad unit containing a rich media ad asset (e.g., ad data corresponding to video, animation, or an interactive ad) during the time when the user device is experiencing reduced network connectivity, the ad modality determiner module 508 may generate instructions to substitute an ad asset requiring reduced network resources, such as a non-interactive ad or an ad containing a static image. Similarly, when the requested ad asset in the ad call message can not be supported due to user device limitations (e.g., current processor load, available memory, as well as hardware and/or software based limitations), the ad modality determiner module 508 identifies an alternate add asset which the user device is able to support.

In various embodiments, the ad modality determiner module 508 takes into account one or both of the network conditions indicators and user device related information in order to evaluate whether the ad asset requested by the user device may be supported. Once the foregoing determination is made, the ad modality determiner 508 instructs the ad tag call constructor module 510 to forward a request to the ad sever 340 (FIGS. 3, 4), via the communication interface 500, to return an ad unit having the supported ad asset. The ad server 340 returns the requested ad unit via an ad server response message. The requested ad unit is forwarded to the user device in an ad call response message via the communication interface 500.

While embodiments of FIGS. 3-5 separately illustrate the ad sever 340 and ad modality selection server 370, in some embodiments, the ad server 340 may include the ad modality selection functionality described herein.

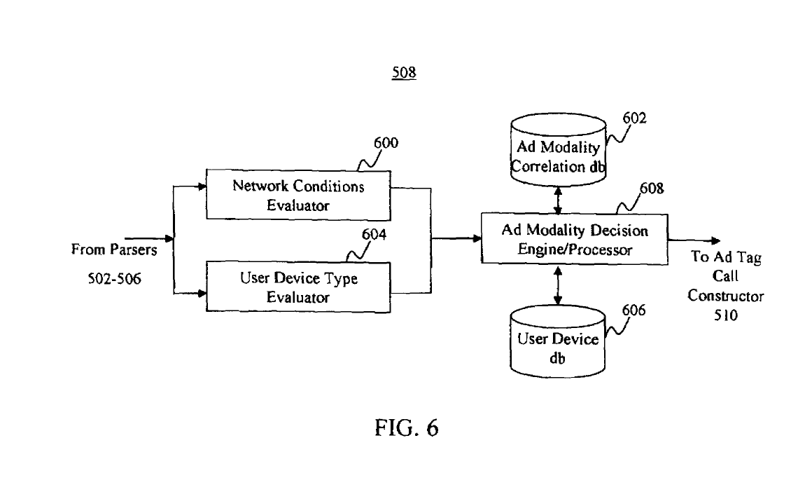

FIG. 6 illustrates an embodiment of the Ad modality determiner module 508 of FIG. 5 in further detail. The network conditions evaluator assigns network parameter ranges to predetermined values and forwards the assigned network parameter value(s) to the ad modality decision processor 608. For instance, a particular range of time values for network latency may correspond to a numeric value range from 1 to 10, with 10 indicating highest latency. In an alternate embodiment the network conditions evaluator calculates an average network conditions score based on determining network parameter values for a plurality of network parameters.

The ad format decision processor 608 accesses an ad modality correlation database 602 to determine whether the ad asset requested by the user device can be supported in view of calculated network conditions score(s). If the network conditions score falls within the range of scores corresponding to the requested ad asset, then the ad modality decision processor instructs the ad tag call constructor 510 (FIG. 5), to initiate an ad server request for the ad unit having the requested ad asset. Otherwise, the ad modality decision processor 608 instructs the ad tag call constructor 510 to initiate an ad server request for an ad unit having a reduced ad asset based on corresponding information in the ad modality correlation database 602.

Additionally, with respect to the user device related information included in the ad tag call, the ad modality decision processor 608 consults the user device database 606 to identify whether the user device is capable of supporting the requested ad asset and instructs the ad tag call constructor 510 to initiate the request for an ad unit having an appropriate ad asset.

In one embodiment., given a network condition and device capabilities, an optimization engine 608 dynamically explores the possible ad layouts/assets to optimize for the performance objective function defined by an advertiser (e.g., objectives expressed in terms of clicks, conversions, and the like). Once a local optimum is found, the optimization engine 608 exploits that ad asset modality for similar conditions, device capabilities, and/or ads. As an example, the optimization engine tries ad modality options A and B across multiple conditions, device capabilities, and/or ad types, and adapts the ad modality corresponding to best performance for future use.

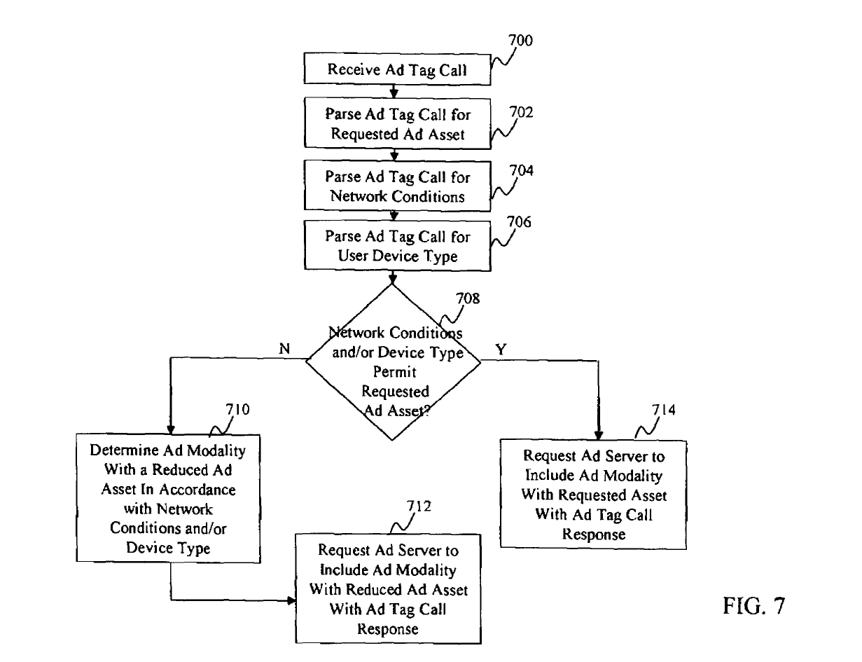

FIG. 7 illustrates an embodiment of a method for adjusting delivery of electronic advertisement to a user device. In step 700, the Ad modality selection server 370 receives an Ad tag Call message from the user device 310. In steps 702-706, the Ad modality selection server 370 parses the Ad tag Call message to identify the requested ad asset (e.g., static image, audio and/or video, animation, or interactive ad format data), as well as any included indicators of one more network conditions and/or device type parameters discussed above in connection with FIGS. 1-6. In step 708, the Ad modality selection server 370 processes the network conditions and/or device type parameters in the Ad tag Call to determine whether delivery of the requested ad asset will degrade the user experience. For instance, if delivery of the requested ad asset is likely to cause the user session to terminate or experience increased delay, such as due to the network QoS falling below a predetermined threshold or when the user device has predetermined limitations (e.g., those related to processor, screen, or memory), the Ad modality selection server 370 determines an ad modality associated with a reduced ad asset which will not degrade the user experience, step 710. In the above situation, the Ad modality selection server 370 modifies the Ad tag Call message by substituting a request for a reduced ad asset and requests the Ad Server 340 to return such ad asset with the Ad tag call response to the user device, step 712. If, however, the ad asset requested in the original Ad tag Call from the user device is supported in view of the current network conditions and/or user device parameters, then the Ad modality selection server 370 requests the Ad Server 340 to include the ad asset in the requested modality with the Ad tag call response to the user device, step 714.

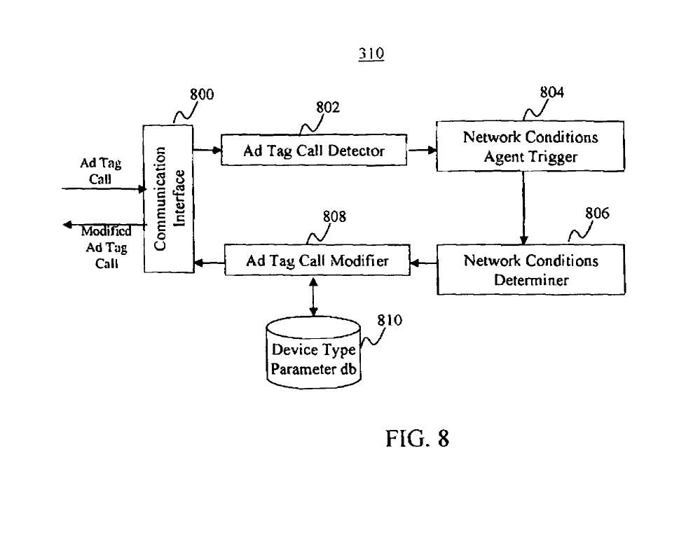

FIG. 8 illustrates an embodiment of the user device 310 of FIGS. 3-4 in further detail. The communication interface 800 forwards web page code with an embedded Ad tag to an Ad tag Call Detector Module 802. Upon detecting an Ad tag in the web page, the Ad tag Call Detector 802 forwards the Ad tag information to the Network Conditions Agent Trigger Module 804 for invoking a process to determine the current network conditions seen by the user device. In an embodiment, the Network Conditions Agent Trigger 804 utilizes a reachability Application Programming Interface (API) or an agent process embedded in a client application running on the user device to determine current network conditions. In another embodiment, the user device communicates with a reachability application running on a server, such as the Ad modality selection server 370, to initiate messaging used to determine network latency and/or other network conditions.

The Network Conditions Determiner Module 806, in turn, receives input of one or more parameters indicative of network conditions from the Network Conditions Agent Trigger 804 to further process the network conditions related data. In an embodiment, the Network Conditions Determiner 806 calculates the network QoS or other aggregate network conditions data and forwards this information to the Ad tag Call Modifier Module 808. The Ad tag Call Modifier 808 accesses a device type parameter database 810 to collect user device parameters and incorporates the user device parameters and one or more network conditions indicators into an Ad tag Call message. The Communication Interface 800 then forwards the modified Ad tag Call to the Ad modality selection server 370 for further processing as described above.

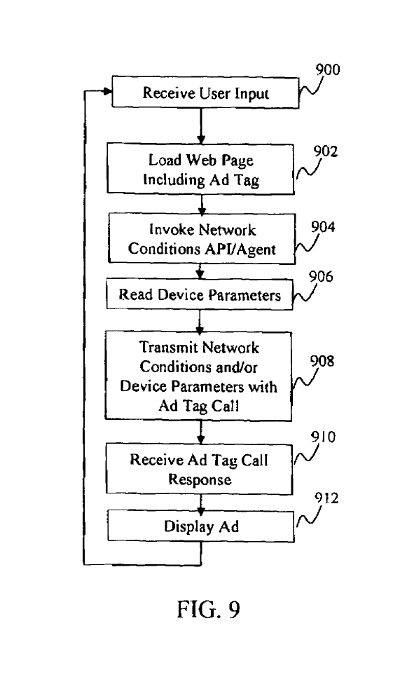

FIG. 9 illustrates an embodiment of a method for processing an ad request by the user device 310 of FIGS. 3-4. In step 900, the user device 310 receives user input, such as input causing a web browser application running on the user device to navigate to a particular web page. In step 902, the user device 310 begins loading the web page, including an Ad tag embedded therein. In steps 904, the user device 310 invokes an API or an application agent to ascertain the current network conditions. In steps 906-908, the user device reads the device parameters and transmits the network conditions and/or the device parameters to the Ad modality selection server 370 via an Ad tag Call. In step 910, the user device 310 receives an Ad tag call response from the Ad modality selection server 370, including an ad unit having an ad asset appropriate for the current network condition and/or user device parameters. Finally, in step 912, the user device 310 displays the received ad unit for the user via the loaded web page.

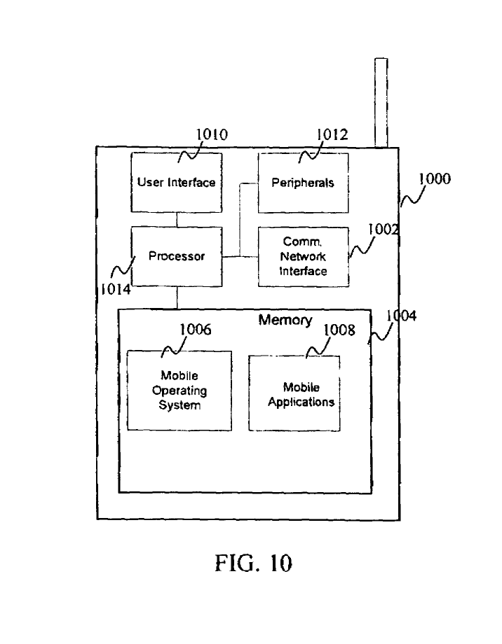

FIG. 10 illustrates an embodiment of a user device 310. In the illustrated embodiment, the user device 310 is a wireless device, such as a cellular telephone 1000 having a communication interface 1002 compatible with the network 380. The mobile device 1000 further includes a processor 1014 executing computer readable instructions stored in memory 1004, including instructions corresponding to the mobile operating system 1006 and mobile applications 1008. The mobile device 1000 further includes peripherals 1012, such as USB connectors for data transfer and charging. The user interface 1010 includes a touch screen and/or a keyboard for receiving user input and displaying the content, including ad units delivered to the mobile device via the ad modality selection server 370.

Generally, to implement the present teaching, computer hardware platforms may be used as the hardware platform(s) for one or more of the elements described herein (e.g., the ad modality selection server 370, ad server 340, ad database 350, and/or the user device 310). The hardware elements, operating systems and programming languages of such computers are conventional in nature, and it is presumed that those skilled in the art are adequately familiar therewith to adapt those technologies to implement the ad modality/format selection and modification as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

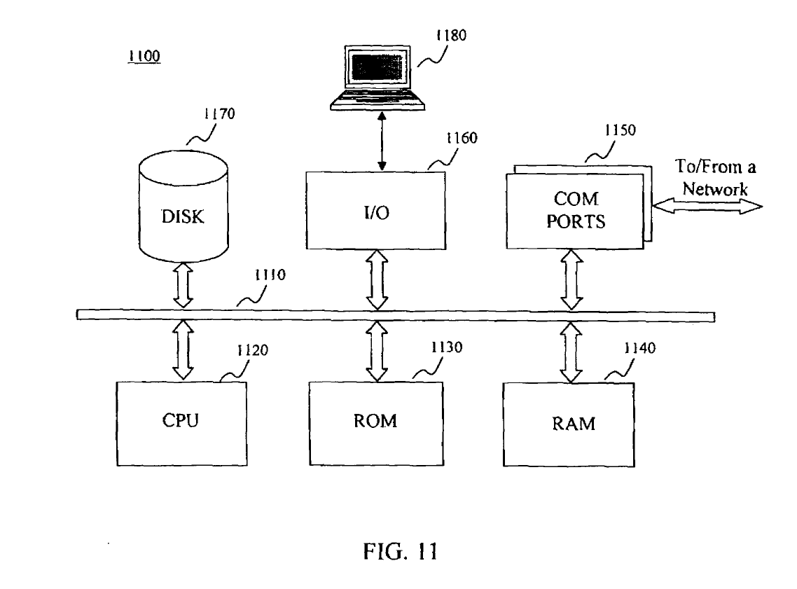

FIG. 11 depicts a general computer architecture on which the present teaching can be implemented and has a functional block diagram illustration of a computer hardware platform which includes user interface elements. The computer may be a general purpose computer or a special purpose computer. This computer 1100 can be used to implement any components of the ad modality selection server 370 as described herein, including via hardware, software program, firmware, or a combination thereof. Although only one such computer is shown, for convenience, the computer functions relating to ad modality selection may be implemented in a distributed fashion on a number of similar platforms, to distribute the processing load.

The computer 1100, for example, includes COM ports 1150 connected to and from a network connected thereto to facilitate data communications. The computer 1100 also includes a central processing unit (CPU) 1120, in the form of one or more processors, for executing program instructions. The exemplary computer platform includes an internal communication bus 1110, program storage and data storage of different forms, e.g., disk 1170, read only memory (ROM) 1130, or random access memory (RAM) 1140, for various data files to be processed and/or communicated by the computer, as well as possibly program instructions to be executed by the CPU. The computer 1100 also includes an I/O component 1160, supporting input/output flows between the computer and other components therein such as user interface elements 1480. The computer 1100 may also receive programming and data via network communications.

Hence, at least some aspects of the methods of the methods described herein may be embodied in programming. Program aspects of the technology may be thought of as “products” or “articles of manufacture” typically in the form of executable code and/or associated data that is carried on, embodied in, or physically stored on a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, among the search engine 330, ad modality selection server 370, and/or ad server 340. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the ad modality selection server and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method for adjusting delivery of electronic advertisement to a user device, the method implemented on a computing device having at least one processor, storage, and a communication interface connected to a network, comprising:
receiving a request for an electronic advertisement asset, where the request includes one or more indicators associated with at least one of the user device and at least one network condition in relation to the user device;
determining a modality of delivery of the electronic advertisement asset based on the one or more indicators; and
transmitting the electronic advertisement asset in the determined modality to the user device in response to the request.

2. The method of claim 1 further comprising determining a modality having a reduced electronic advertisement asset when the one or more indicators do not permit delivery of the electronic advertisement asset in the request.

3. The method of claim 2 wherein the reduced electronic advertisement asset comprises one of an interactive advertisement and a static advertisement and the electronic advertisement asset in the request comprises a video advertisement.

4. The method of claim 2 wherein the reduced electronic advertisement asset comprises a static advertisement and the electronic advertisement asset in the request comprises one of an interactive advertisement and an animated advertisement.

5. The method of claim 1 further comprising delivering the electronic advertisement in a modality having the electronic advertisement asset when the one or more indicators permit delivery of the electronic advertisement asset in the request.

6. The method of claim 1 wherein the electronic advertisement asset request comprises an ad tag call.

7. The method of claim 1 wherein the one or more network conditions includes a network condition selected from the group consisting of a quality of service indicator, a received signal strength indicator, a latency indicator, and an error rate indicator.

8. The method of claim 1 wherein the user device is a mobile device.

9. A system for adjusting delivery of electronic advertisement to a user device, the system comprising:
a network conditions parser module configured to parse an electronic advertisement asset request for one or more indicators associated with at least one of the user device and at least one network condition in relation to the user device;
an advertisement modality determiner module configured to determine a modality for delivery of the electronic advertisement by identifying whether an electronic advertisement asset in the request is supported for the one or more indicators; and
an electronic advertisement request constructor module configured to cause delivery of the electronic advertisement to the user device in accordance with the determined format.

10. The system of 9 wherein the advertisement modality determiner module is further configured to determine a modality having a reduced electronic advertisement asset when the one or more indicators do not permit delivery of the electronic advertisement asset in the request.

11. The system of claim 10 wherein the reduced electronic advertisement asset comprises one of an interactive advertisement and a static advertisement and the electronic advertisement asset in the request comprises a video advertisement.

12. The system of claim 10 wherein the reduced electronic advertisement asset comprises a static advertisement and the electronic advertisement asset in the request comprises one of an interactive advertisement and an animated advertisement.

13. The system of claim 9 wherein the electronic advertisement request constuctor module is further configured to cause delivery of the electronic advertisement in a modality having the electronic advertisement asset when the one or more indicators permit delivery of the electronic advertisement asset in the request.

14. The system of claim 9 wherein the electronic advertisement asset request comprises an ad tag call.

15. The system of claim 9 wherein the one or more network conditions includes a network condition selected from the group consisting of a quality of service indicator, a received signal strength indicator, a latency indicator, and an error rate indicator.

16. The system of claim 9 wherein the user device is a mobile device.

17. A non-transitory computer readable medium having recorded thereon information for delivering electronic advertisement to a user device, wherein the information, when read by the computer, causes the computer to perform the steps of:
receiving an electronic advertisement asset request having one or more indicators associated with at least one of the user device and at least one network condition in relation to the user device;
determining a modality for delivery of the electronic advertisement by identifying whether an electronic advertisement asset in the request is supported for the one or more indicators; and
transmitting the electronic advertisement asset in the determined modality to the user device in response to the request.

18. The computer readable medium of claim 17 wherein the instructions further cause the computer to perform the step of determining a modality having a reduced electronic advertisement asset when the one or more indicators do not permit delivery of the electronic advertisement asset in the request.

19. The computer readable medium of claim 17 wherein the instructions further cause the computer to perform the step of delivering the electronic advertisement in a modality having the electronic advertisement asset when the one or more indicators permit delivery of the electronic advertisement asset in the request.

20. The computer readable medium of claim 17 wherein the user device is a mobile device and the one or more network conditions includes a network condition selected from the group consisting of a quality of service indicator, a received signal strength indicator, a latency indicator, and an error rate indicator.
